(19) United States
(12) Patent Application Publication
(10) Pub. No.: US 2023/0260005 A1
(43) Pub. Date: Aug. 17, 2023

(54) SMART WINDOW DISPLAY, AND METHOD FOR OPERATING SMART WINDOW DISPLAY

(71) Applicant: LG ELECTRONICS INC., Seoul (KR)

(72) Inventors: Ankith GUNAPAL, Santa Clara, CA (US); Jinyoung AHN, Santa Clara, CA (US); Purvee JAIN, Santa Clara, CA (US); Gaurav SARAF, Santa Clara, CA (US); Fanya YOUNG, Santa Clara, CA (US)

(73) Assignee: LG ELECTRONICS INC., Seoul (KR)

(21) Appl. No.: 18/012,438

(22) PCT Filed: Jun. 22, 2021
(86) PCT No.: PCT/KR2021/007795

§ 371 Date: Apr. 28, 2023

Related U.S. Application Data
(60) Provisional application No. 63/042,538, filed on Jun. 22, 2020.

(51) Int. Cl. G06Q 30/0601; G06Q 30/0251; G06Q 20/10; G06Q 10/087; G06V 40/10; G06T 13/40

(52) U.S. Cl. CPC G06Q 30/0631; G06Q 30/0639; G06Q 30/0643; G06Q 30/0271; G06Q 20/102; G06Q 10/087; G06V 40/10; G06T 13/40

(57) ABSTRACT

The present invention provides a smart window display comprising: a display; a camera for identifying a user; a communication unit for communicating with an external device; and a control unit, wherein the control unit provides a personalized recommendation on the basis of the physical characteristics and style characteristics of the user identified through the camera, and when a signal to purchase a product in the personalized recommendation is received from the user after the personalized recommendation is provided, performs a payment process for the product.

### TECHNICAL FIELD

The present disclosure relates to a smart window display and, more particularly, to a smart window display that provides personalized recommendations to a user.

### BACKGROUND

As an Internet purchasing system for purchasing goods online has been developed and commercialized with the development of the Internet, it is possible for customers to make a purchase without the need to go to an offline shopping mall. However, Internet shopping may often cause delivery accidents of goods and deteriorate the reliability of purchased goods due to the nature of online shopping. Accordingly, the number of shoppers who feel the need to use offline shopping has increased, and offline shopping spaces such as large stores are expanding in order to secure such shoppers.

Shoppers who visit these offline stores want to enjoy the advantage of fitting clothes that suit their physical attributes and style. However, when there are fewer employees in the store due to a recent increase in minimum wage or when all employees in the store are busy, the case in which it is difficult for shoppers to get advice on their style frequently occurs.

### SUMMARY

Accordingly, the present disclosure is directed to a smart window display and an operating method thereof that substantially obviate the above-described problem or other problems due to limitations and disadvantages of the related art.

An object of the present disclosure is to provide personalized recommendations to a user through a smart window display.

The objects to be achieved by the present disclosure are not limited to what has been particularly described hereinabove and other objects not described herein will be more clearly understood by persons skilled in the art from the following detailed description.

To achieve these objects and other advantages and in accordance with the purpose of the disclosure, as embodied and broadly described herein, a smart window display includes a display, a camera configured to identify a user, a communication unit configured to communicate with an external device, and a controller. The controller provides personalized recommendations based on user attributes and style attributes of the user identified through the camera and performs a payment process of a product to be purchased in the personalized recommendations based on reception of a signal related to purchase of the product from the user after providing the personalized recommendations.

The controller may receive a purchase history of the user of the external device from the external device through the communication unit and provide the personalized recommendations based on the received purchase history.

The controller may analyze a preference of the user of the external device based on the purchase history of the user of the external device from the external device and provide the personalized recommendations based on the analyzed preference.

The controller may receive the preference from the external device.

The controller may access a store management system through the communication unit, receive an inventory history from the store management system, and provide the personalized recommendations based on the inventory history.

The signal related to purchase of the product may include at least one of a gesture signal of the user through the camera or a touch signal of the user through the display.

The controller may perform the payment process through the store management system.

The user attributes may include personal attributes, physical attributes, and color attributes of the user.

The style attributes of the user may include at least one of attributes of clothes worn currently by the user and attributes of accessories worn currently by the user, and the attributes of the clothes and the attributes of the accessories may include at least one of color, texture, fabric, size, a sleeve type, a sleeve length, a pocket, and a neckline.

The controller may output a guide window for guiding the user to visit a related store after providing the personalized recommendations based on the identified user being located outsice of the store.

The controller may configure a priority between the user attributes and the style attributes of the identified user according to a preset value and provide the personal recommendations based on the configured priority.

The camera may be integrated with the smart window display by being installed inside the smart window display.

The camera may be attachable to or detachable from the smart window display.

The controller may generate a virtual avatar based on the identified user and output the personalized recommendations by applying the personalized recommendations to the avatar.

In another aspect of the present disclosure, an operating method of a smart window display includes identifying a user through a camera, providing personalized recommendations based on user attributes and style attributes of the identified user, and performing a payment process of a product to be purchased in the personalized recommendations based on reception of a signal related to purchase of the product from the user after providing the personalized recommendations.

The effects of the smart window display and a control method thereof according to the present disclosure are as follows.

According to at least one of embodiments of the present disclosure, a smart window display may improve the visibility of a product.

According to at least one of embodiments of the present disclosure, the smart window display may increase the sales of a store.

According to at least one of embodiments of the present disclosure, the smart window display may increase the amount of walking by shoppers in front of a store in which the smart window display is installed.

Further scope of applicability of the present disclosure will become apparent from the detailed description given hereinbelow.

However, it should be understood that the detailed description and specific examples of the present disclosure are illustrative only and various changes and modifications made within the spirit and scope of the disclosure will become apparent to those skilled in the art from this detailed description.

### BRIEF DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a diagram illustrating the overall operation of a smart window display according to an embodiment of the present disclosure;

FIG. 2 is a diagram illustrating the configuration of a smart window display according to an embodiment of the present disclosure.

FIG. 3 is a diagram illustrating a purchase process of a smart window display according to an embodiment of the present disclosure;

FIG. 4 is a diagram illustrating an embodiment in which a smart window display according to an embodiment of the present disclosure is installed outside a store;

FIG. 5 is a diagram illustrating an embodiment in which a smart window display according to an embodiment of the present disclosure provides personalized recommendations by checking inventory details;

FIG. 6 is a diagram illustrating an embodiment in which a smart window display provides personalized recommendations using an avatar of an identified user according to an embodiment of the present disclosure;

FIG. 7 is a diagram illustrating an embodiment in which a smart window display differently provides personalized recommendations for each brand according to an embodiment of the present disclosure; and

FIG. 8 is a flowchart illustrating an embodiment in which a smart window display provides personalized recommendations according to an embodiment of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

In the present application, terms such as “include” or “has” are used herein and should be understood that they are intended to indicate an existence of several components, functions or steps, disclosed in the specification, and it is also understood that greater or fewer components, functions, or steps may likewise be utilized.

Artificial Intelligence (AI) refers to a field that studies artificial intelligence or methodology capable of achieving artificial intelligence. Machine learning refers to a field that defines various problems handled in the AI field and studies methodology for solving the problems.

In addition, AI does not exist on its own, but is rather directly or indirectly related to other fields in computer science. In recent years, there have been numerous attempts to introduce an AI element into various fields of information technology to use AI to solve problems in those fields.

Machine learning is an area of AI including the field of study that assigns the capability to learn to a computer without being explicitly programmed.

Specifically, machine learning may be a technology for researching and constructing a system for learning based on empirical data, performing prediction, and improving its own performance and researching and constructing an algorithm for the system. Algorithms of machine learning take a method of constructing a specific model in order to derive prediction or determination based on input data, rather than performing strictly defined static program instructions.

The term machine learning may be used interchangeably with the term machine learning.

Numerous machine learning algorithms have been developed in relation to how to classify data in machine learning. Representative examples of such machine learning algorithms include a decision tree, a Bayesian network, a support vector machine (SVM), and an artificial neural network (ANN).

The decision tree refers to an analysis method that plots decision rules on a tree-like graph to perform classification and prediction.

The Bayesian network is a model that represents the probabilistic relationship (conditional independence) between a plurality of variables in a graph structure. The Bayesian network is suitable for data mining through unsupervised learning.

The SVM is a supervised learning model for pattern recognition and data analysis, mainly used in classification and regression analysis.

The ANN is a data processing system in which a plurality of neurons, referred to as nodes or processing elements, is interconnected in layers, as a model of the interconnection relationship between the operation principle of biological neurons and neurons.

The ANN is a model used in machine learning and includes a statistical learning algorithm inspired by a biological neural network (particularly, the brain in the central nervous system of an animal) in machine learning and cognitive science.

Specifically, the ANN may mean a model having a problem-solving ability by changing the strength of connection of synapses through learning at artificial neurons (nodes) forming a network by connecting synapses.

The term ANN may be used interchangeably with the term neural network.

The ANN may include a plurality of layers, each including a plurality of neurons. In addition, the ANN may include synapses connecting neurons.

The ANN may be generally defined by the following three factors: (1) a connection pattern between neurons of different layers; (2) a learning process that updates the weight of a connection; and (3) an activation function for generating an output value from a weighted sum of inputs received from a previous layer.

The ANN includes, without being limited to, network models such as a deep neural network (DNN), a recurrent neural network (RNN), a bidirectional recurrent deep neural network (BRDNN), a multilayer perceptron (MLP), and a convolutional neural network (CNN).

The ANN is classified as a single-layer neural network or a multilayer neural network according to the number of layers. A general single-layer neural network includes an input layer and an output layer. In addition, a general multilayer neural network includes an input layer, one or more hidden layers, and an output layer.

The input layer is a layer that accepts external data. The number of neurons of the input layer is equal to the number of input variables. The hidden layer is disposed between the input layer and the output layer. The hidden layer receives a signal from the input layer and extract characteristics. The hidden layer transfers the characteristics to the output layer. The output layer receives a signal from the hidden layer and outputs an output value based on the received signal. Input signals of neurons are multiplied by respective strengths (weights) of connection and then are summed. If the sum is larger than a threshold of the neuron, the neuron is activated to output an output value obtained through an activation function.

The DNN including a plurality of hidden layers between an input layer and an output layer may be a representative ANN for implementing deep learning which is machine learning technology.

The ANN may be trained using training data. Herein, training may mean a process of determining parameters of the ANN using training data for the purpose of classifying, regressing, or clustering input data. Representative examples of the parameters of the ANN may include a weight assigned to a synapse or a bias applied to a neuron.

The ANN trained by the training data may classify or cluster input data according to the pattern of the input data. Meanwhile, the ANN trained using the training data may be referred to as a trained model in the present specification.

Next, a learning method of the ANN will be described.

The learning method of the ANN may be broadly classified into supervised learning, unsupervised learning, semi-supervised learning, and reinforcement learning.

Supervised learning is a method of the machine learning for deriving one function from the training data. Among derived functions, outputting consecutive values may be referred to as regression, and predicting and outputting a class of an input vector may be referred to as classification.

In supervised learning, the ANN is trained in a state in which a label for the training data has been given. Here, the label may refer to a correct answer (or a result value) to be inferred by the ANN when the training data is input to the ANN.

Throughout the present specification, the correct answer (or result value) to be inferred by the ANN when the training data is input is referred to as a label or labeling data.

In the present specification, labeling the training data for training the ANN is referred to as labeling the training data with labeling data. In this case, the training data and a label corresponding to the training data may configure one training set and may be input to the ANN in the form of the training set.

Meanwhile, the training data represents a plurality of features, and labeling the training data may mean labeling the feature represented by the training data. In this case, the training data may represent the feature of an input object in the form of a vector.

The ANN may derive a function of an association between the training data and the labeling data using the training data and the labeling data. Then, the ANN may determine (optimize) the parameter thereof by evaluating the derived function.

Unsupervised learning is a kind of machine learning in which the training data is not labeled. Specifically, unsupervised learning may be a learning method that trains the ANN to discover and classify a pattern in the training data itself rather than the association between the training data and the label corresponding to the training data. Examples of unsupervised learning may include, but are not limited to, clustering and independent component analysis.

Examples of the ANN using unsupervised learning include, but are not limited to, a generative adversarial network (GAN) and an autoencoder (AE).

The GAN is a machine learning method of improving performance through competition between two different AI models, i.e., a generator and a discriminator. In this case, the generator is a model for generating new data and may generate new data based on original data.

The discriminator is a model for discriminating the pattern of data and may serve to discriminate whether input data is original data or new data generated by the generator.

The generator may receive and learn data that has failed to deceive the discriminator, while the discriminator may receive deceiving data from the generator and learn the data. Accordingly, the generator may evolve to maximally deceive the discriminator, while the discriminator may evolve to well discriminate between the original data and the data generated by the generator.

The AE is a neural network which aims to reproduce input itself as output. The AE may include an input layer, at least one hidden layer, and an output layer. Since the number of nodes of the hidden layer is smaller than the number of nodes of the input layer, the dimensionality of data is reduced and thus compression or encoding is performed.

Furthermore, data output from the hidden layer is input to the output layer. In this case, since the number of nodes of the output layer is greater than the number of nodes of the hidden layer, the dimensionality of the data increases and thus decompression or decoding is performed.

Meanwhile, the AE controls the strength of connection of neurons through learning, such that input data is represented as hidden-layer data. In the hidden layer, information is represented by fewer neurons than neurons of the input layer, and reproducing input data as output may mean that the hidden layer finds a hidden pattern from the input data and expresses the hidden pattern.

Semi-supervised learning is a kind of machine learning that makes use of both labeled training data and unlabeled training data. One semi-supervised learning technique involves inferring the label of unlabeled training data and then performing learning using the inferred label. This technique may be useful when labeling cost is high.

Reinforcement learning is a theory that an agent is capable of finding an optimal path based on experience without reference to data when an environment in which the agent may decide what action is taken every moment is given. Reinforcement learning may be mainly performed by a Markov decision process (MDP).

The MDP will be briefly described. First, an environment including information necessary for the agent to take a subsequent action is given. Second, what action is taken by the agent in that environment is defined. Third, a reward given to the agent when the agent successfully takes a certain action and a penalty given to the agent when the agent fails to take a certain action are defined. Fourth, experience is repeated until a future reward is maximized, thereby deriving an optimal action policy.

The ANN may specify the structure thereof by a configuration, an activation function, a loss or cost function, a learning algorithm, and an optimization algorithm, of a model. Hyperparameters may be preconfigured before learning, and model parameters may then be configured through learning to specify the contents of the ANN.

For instance, the structure of the ANN may be determined by factors, including the number of hidden layers, the number of hidden nodes included in each hidden layer, an input feature vector, and a target feature vector.

The hyperparameters include various parameters which need to be initially configured for learning, such as initial values of the model parameters. The model parameters include various parameters to be determined through learning.

For example, the hyperparameters may include an initial value of a weight between nodes, an initial value of a bias between nodes, a mini-batch size, a learning iteration number, and a learning rate. Furthermore, the model parameters may include the weight between nodes and the bias between nodes.

The loss function may be used as an index (reference) for determining an optimal model parameter during a learning process of the ANN. Learning in the ANN may mean a process of manipulating model parameters so as to reduce the loss function, and the purpose of learning may be determining the model parameters that minimize the loss function. The loss function may typically use a means squared error (MSE) or cross-entropy error (CEE), but the present disclosure is not limited thereto.

The CEE may be used when a correct answer label is one-hot encoded. One-hot encoding is an encoding method in which only for neurons corresponding to a correct answer, a correct answer label value is set to be 1 and, for neurons that do not correspond to the correct answer, the correct answer label value is set to be 0.

Machine learning or deep learning may use a learning optimization algorithm to minimize the loss function. Examples of the learning optimization algorithm include gradient descent (GD), stochastic gradient descent (SGD), momentum, Nesterov accelerate gradient (NAG), AdaGrad, AdaDelta, RMSProp, Adam, and Nadam.

GD is a method that adjusts the model parameters in a direction that reduces a loss function value in consideration of the slope of the loss function in a current state. The direction in which the model parameters are adjusted is referred to as a step direction, and a size by which the model parameters are adjusted is referred to as a step size. Here, the step size may mean a learning rate.

GD may obtain a slope of the loss function through partial derivative using each of the model parameters and update the model parameters by adjusting the model parameters by the learning rate in the direction of the obtained slope. SGD is a method that separates training data into mini batches and increases the frequency of GD by performing GD for each mini batch.

AdaGrad, AdaDelta, and RMSProp are methods that increase optimization accuracy in SGD by adjusting the step size. Momentum and NAG are methods that increase optimization accuracy in SGD by adjusting the step direction. Adam is a method that combines momentum and RMSProp and increases optimization accuracy by adjusting the step size and the step direction. Nadam is a method that combines NAG and RMSProp and increases optimization accuracy by adjusting the step size and the step direction.

The learning rate and accuracy of the ANN greatly rely not only on the structure and learning optimization algorithms of the ANN but also on the hyperparameters. Therefore, in order to obtain a good learning model, it is important to configure a proper hyperparameter as well as determining a proper structure and learning algorithm of the ANN. In general, the ANN is trained by experimentally configuring the hyperparameters as various values, and an optimal hyperparameter that provides a stable learning rate and accuracy as a result of learning is configured.

In an embodiment of the present disclosure, a smart window display showing various personal content and expected shoppers may be applied to various shopping stores. Here, the various shopping stores may include, for example, wholesale stores or retail stores that sell clothes etc. In addition, users may correspond to shoppers who visit various shopping stores.

In this case, the smart window display may provide personalized recommendations to a shopper in real time by combining shopper attributes and style attributes of clothes of the shopper. Furthermore, the smart window display may provide the personalized recommendations to the shopper in real time by combining a purchase history and a personal preference of the shopper.

A description related thereto will be given in more detail below with reference to the drawings.

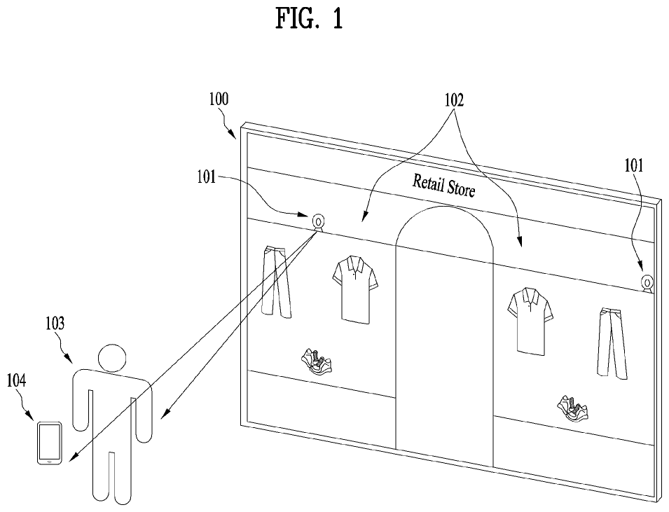

FIG. 1 is a diagram illustrating the overall operation of a smart window display according to an embodiment of the present disclosure.

Referring to FIG. 1, a smart window display 100 may include a camera 101, a display 102, a communication unit (not shown), and a controller (not shown). Although the smart window display 100 may control configuration modules based on the controller, a description will be given in FIG. 1 for convenience under the assumption that operation is performed by the smart window display 100.

In an embodiment of the present disclosure, the smart window display 100 may identify a user 103 using the camera 101. The smart window display 100 may provide personalized recommendations to the user 103 based on user attributes and style attributes of the user 103 identified through the camera 101. In more detail, the smart window display 100 may extract the user attributes and style attributes of the user 103 identified through the camera 101.

More specifically, the camera 101 of the smart window display 100 may distinguishably identify personal attributes, physical attributes, and color attributes as the user features. Here, the personal attributes may include a style, a fit, a silhouette, etc., of a person, the physical attributes may include a body type, an age, a gender, etc., and the color attributes may include hair color, eye color, skin tone, etc.

The camera 101 of the smart window display 100 may identify the style attributes through clothes and accessories currently worn by the user 103. In more detail, the camera 101 may identify fashion attributes such as color, texture, fabric, a sleeve type, a sleeve length, and a neckline of the clothes and accessories currently worn by the user 103.

More specifically, the camera 101 of the smart window display 100 may identify trend, clothes color, pattern, material, clothes size, sleeve length, a sleeve type, a pocket, a neckline, etc., as attributes of the clothes and accessories currently worn by the user 103.

Accordingly, the smart window display 100 may provide personalized recommendations based on the clothes and accessories currently worn by the user 103.

In an embodiment of the present disclosure, the smart window display 100 may assign priority to the above-described user attributes and style attributes of the user 103 and analyze the same. More specifically, the smart window display 100 may provide the personalized recommendations by assigning a higher priority to the user attributes than the style attributes of the user 103. Similarly, the smart window display 100 may provide the personalized recommendations by assigning a higher priority to the personal attributes than the physical attributes among the user attributes.

In this case, [drawing 1] shows an example of the priority of the user attributes and style attributes of the user 103 of the smart window display 100 according to an embodiment of the present disclosure.

Accordingly, in an embodiment of the present disclosure, the smart window display 100 may provide the personalized recommendations to the user 103 through the display 102.

In an embodiment of the present disclosure, the smart window display 100 may receive a past purchase history and a personal preference of the user 103 from an identified digital device 104 of the user using a communication unit. In other words, when the user 103 has the digital device 104 (e.g., a smartphone), the smart window display 100 may be synchronized with the digital device 104 of the user 103 by communicating with the digital device 104 of the user 103. For example, the smart window display 100 and the digital device 104 may be synchronized using communication technology such as Bluetooth.

In an embodiment of the present disclosure, the smart window display 100 may receive the purchase history or the personal preference of the user 103 from the digital device 104 of the user 103. Accordingly, the smart window display 100 may provide the personalized recommendations, in real time, including the purchase history and the personal preference as well as user attributes and currently worn fashion attributes.

In this case, the smart window display 100 may receive the past purchase history and the preference of the user 103 from the digital device 104 in real time or based on a preset time period.

In another embodiment of the present disclosure, the smart window display 100 may receive only the past purchase history of the user 103 from the digital device 104 and may directly analyze the preference of the user 103 through the controller.

Accordingly, the smart window display 100 may output the personalized recommendations on the display 102 based on at least one of the user attributes, style attributes, purchase history, and preferences of the user 103.

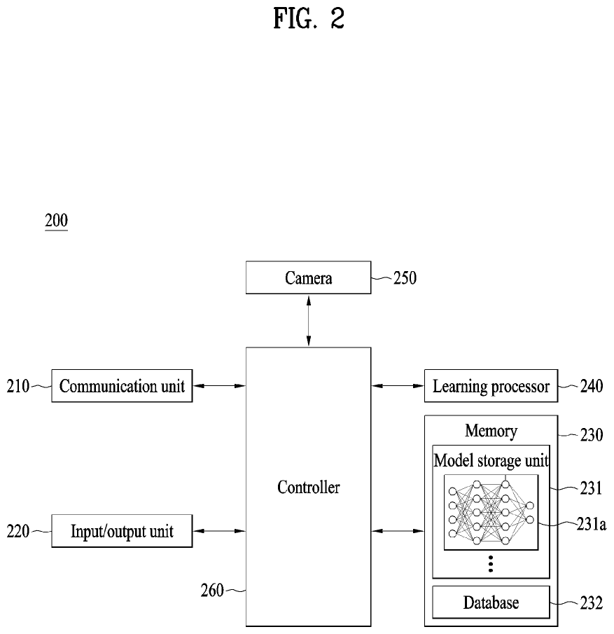

FIG. 2 is a diagram illustrating the configuration of a smart window display according to an embodiment of the present disclosure.

Referring to FIG. 2, a smart window display 200 may include a communication unit 210, an input/output unit 220, a memory 230, a learning processor 240, a camera 250, and a controller 260.

The communication unit 210 may transmit/receive data to and from other devices through wired/wireless communication or an interface. The communication unit 210 may include at least one of a mobile communication module, a wireless Internet module, and a short-range communication module.

The mobile communication module transmits and receives a radio signal to and from at least one of a base station (BS), an external terminal, and a server over a mobile communication network established according to technical standards or communication methods for mobile communication (e.g., global system for mobile communication (GSM), code division multiple access (CDMA), code division multiple access 2000 (CDMA2000), enhanced voice-data optimized or enhanced voice-data only (EV-DO), wideband CDMA (WCDMA), high speed downlink packet access (HSDPA), high speed uplink packet access (HSUPA), long-term evolution (LTE), long-term evolution-advanced (LTE-A), etc.).

The wireless Internet module refers to a module for wireless Internet access and may be built in the smart window display 200 or may be externally installed outside of the smart window display 200. The wireless Internet module is configured to transmit and receive wireless signals over a communication network according to wireless Internet technologies.

The short-range communication module is for short-range communication. At least one of Bluetooth™, radio frequency identification (RFID), infrared data association (IrDA), ultra-wideband (UWB), ZigBee, near-field communication (NFC), wireless-fidelity (Wi-Fi), Wi-Fi Direct, or wireless universal serial bus (USB) may be used to support short-range communication. The short-range communication module may support, through a wireless area network, wireless communication between the smart window display 200 and a wireless communication system or between the smart window display 200 and another digital device 100. The wireless area network may be a wireless personal area network.

The input/output unit 220 may include both an input unit and an output unit. That is, the input unit may include a microphone or an audio input unit for inputting an audio signal, and a user input unit (e.g., a touch key, a push key, etc.) for receiving information from a user. Voice data or image data collected from the input unit may be analyzed and processed as a control command of the user.

The output unit serves to generate visual, auditory, or tactile output and may include at least one of a display, a sound output unit, and an optical output unit. The display may implement a touchscreen by forming a layered structure with a touch sensor or being integrally formed together with the touch sensor. The display may function as a user input unit that provides an input interface between the smart window display 200 and may provide an output interface between the smart window display 200 and the user.

The memory 230 stores data supporting various functions. The memory 230 may store a plurality of application programs (or applications) driven by the smart window display 200, and data and instructions for operation of the smart window display 200. At least some of these application programs may be downloaded from an external server through wireless communication. Meanwhile, the application programs may be stored in the memory 230, installed in the smart window display 200, and driven to perform operations (or functions) of the mobile terminal by the controller 260.

The memory 230 may include a model storage unit 231 and a database 232.

The model storage unit 231 may store a model which is being trained or has been trained through a learning processor 240 (or artificial neural network 231a). If the model is updated through learning, the model storage unit 231 stores the updated model. As needed, the model storage unit 231 may divide trained models into a plurality of versions according to a learning time point or a learning progress level and then store the models.

The artificial neural network 231a illustrated in FIG. 2 is purely an example of an artificial neural network including a plurality of hidden layers and an artificial neural network of the present disclosure is not limited thereto. The artificial neural network 231a may be implemented as hardware, software, or a combination of hardware and software. When a part or all of the artificial neural network 231a is implemented as software, one or more instructions constituting the artificial neural network 231a may be stored in the memory 230.

The database 232 stores input data obtained from the input unit 220, learning data (or training data) used for model learning, and a learning history of a model. The input data stored in the database 232 may be unprocessed input data as well as data processed to be suitable for model learning.

The learning processor 240 learns a model including an artificial neural network using training data. Specifically, the learning processor 240 may determine optimized model parameters of the artificial neural network by repeatedly training the artificial neural network using the various learning techniques described above.

In the present specification, an artificial neural network, parameters of which are determined by being trained using the training data, may be referred to as a learning model or a trained model. In this case, the learning model may be used to infer a result value with respect to new input data rather than to the training data.

The learning processor 240 may be configured to receive, classify, store, and output information to be used for data mining, data analysis, intelligent decision making, and machine learning algorithms and techniques.

The learning processor 240 may include one or more memory units configured to store data received, detected, sensed, generated, predefined, or output by another component, device, or terminal or by an apparatus communicating with the terminal.

The learning processor 240 may include a memory integrated with or implemented in the smart window display. In some embodiments, the learning processor 240 may be implemented using the memory 230.

The learning processor 240 may generally be configured to store data in one or more databases to identify, index, categorize, manipulate, store, retrieve, and output data for use in supervised or unsupervised learning, data mining, predictive analysis, or machine learning.

The information stored in the learning processor 240 may be utilized by the controller 260 using any of a variety of different types of data analysis algorithms and machine learning algorithms.

Examples of such algorithms include k-nearest neighbor systems, fuzzy logic (e.g., probability theory), neural networks, Boltzmann machines, vector quantization, pulse neural networks, support vector machines, maximum margin classifiers, hill climbing, inductive logic system Bayesian networks, Petri nets (e.g., finite state machines, Mealy machines, or Moore finite state machines), classifier trees (e.g., perceptron trees, support vector trees, Markov trees, decision tree forests, or random forests), decoding models and systems, artificial fusion, sensor fusion, image fusion, reinforcement learning, augmented reality, pattern recognition, and automated planning.

The learning processor 240 may train (or learn) the artificial neural network 231a using training data or a training set.

The learning processor 240 may train the artificial neural network 231a by directly acquiring data obtained by preprocessing input data obtained by the controller 260 through the input unit 220 or train the artificial neural network 231a by acquiring preprocessed input data stored in the database 232.

Specifically, the learning processor 240 may determine optimized model parameters of the artificial neural network 231a by repeatedly training the artificial neural network 231a using the various learning techniques described above.

In the present specification, an artificial neural network, parameters of which are determined by being trained using training data, may be referred to as a learning model or a trained model.

The camera 250 processes an image frame such as a still image or a moving image obtained by an image sensor. The processed image frame may be displayed on the display or stored in the memory 230. On the other hand, a plurality of cameras 250 provided in the smart window display 200 may be arranged to form a matrix structure. A plurality of image information having various angles or foci may be input to the smart window display 200 through the cameras 250 having the matrix structure. In addition, the cameras 250 may be arranged in a stereoscopic structure to acquire a left image and a right image for realizing a stereoscopic image.

The smart window display 200 may be configured to receive, classify, store and output information to be used for data mining, data analysis, intelligent decision making, and machine learning algorithms through the controller 260. Here, the machine learning algorithm may include a deep learning algorithm.

The smart window display 200 may communicate with at least one external digital device (e.g., 104 of FIG. 1) and derive a result by analyzing or learning data, on behalf of the digital device or by helping other devices. Here, helping other devices may mean distribution of computing power through distributed processing.

The controller 260 of the smart window display 200 may generally mean a server as various devices for training the artificial neural network and may be referred to as a learning device or a learning server. In particular, the controller 260 of the smart window display 200 may be implemented not only as a single server but also as a plurality of server sets, cloud servers, or a combination of the server sets and the cloud servers.

That is, a plurality of controllers 260 may be configured to form a learning device set (or a cloud server). At least one or more smart window displays 200 included in the learning device set may derive a result by analyzing or training data through distributed processing. Hereinafter, embodiments performed by the smart window display may be performed by the controller 260 described above with reference to FIG. 2.

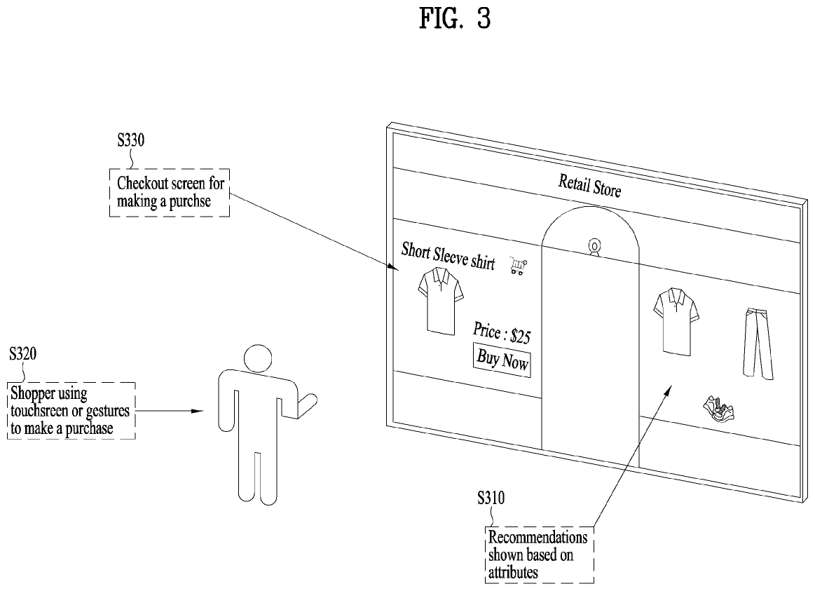

FIG. 3 is a diagram illustrating a purchase process of a smart window display according to an embodiment of the present disclosure.

Referring to FIG. 3, in step S310, the smart window display may provide personalized recommendations through a display. In this case, the smart window display may provide the personalized recommendations based on user attributes and style attributes of a previously identified user.

In step S320, after the personalized recommendations are provided, the smart window display may receive a signal for purchasing a product in the personalized recommendations from the user. In this case, the signal for making a purchase may include at least one of a gesture signal of the user through a camera or a touch signal of the user through the display. For example, the smart window display may receive a gesture or touch signal of a shopper. More specifically, the smart window display may receive the gesture signal of the shopper through the camera and receive the touch signal of the shopper through the display configured as a touchscreen.

In step S330, the smart window display may perform a payment process for the product in the personalized recommendations. In this case, the smart window display may receive the payment process for the product by accessing a store management system through a communication unit. In addition, the smart window display may receive a gesture signal or a touch signal from the shopper again for payment for the product. Although not illustrated in the drawings, the smart window display may output the payment process through the display.

In one embodiment of the present disclosure, the smart window display may interact with the shopper using touchscreen technology or using gesture technology based on non-touch gesture technology. In addition, even when the shopper does not enter the store, the payment process may be performed in a place in which the smart window display is installed. Accordingly, the shopper may purchase products provided based on the personalized recommendations without entering the store.

Therethrough, the shopper may purchase a recommended product without going around the store, and the store may maximize profits because the shopper directly purchases the product.

Although not illustrated in the drawing, in another embodiment of the present disclosure, when the shopper wants to purchase a product in the personalized recommendations after the smart window display provides the personalized recommendations to the shopper outside the store, the smart window display may output a guide window for guiding the shopper to visit the store to make a purchase.

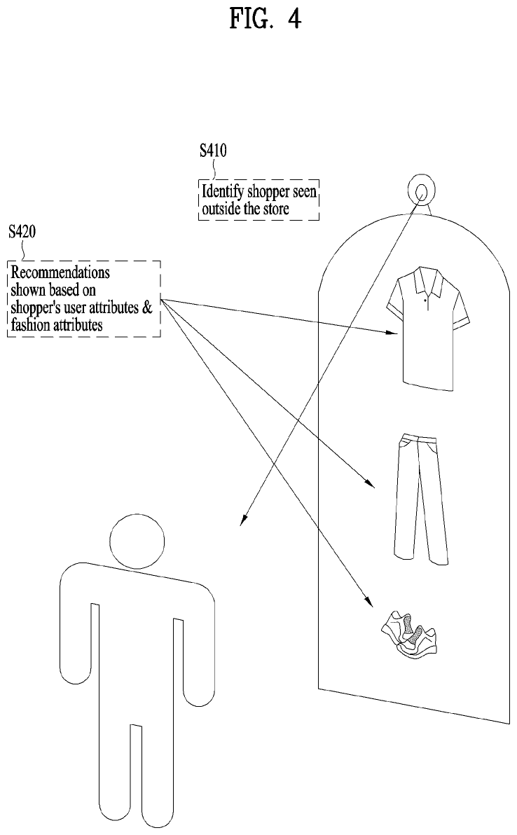

FIG. 4 is a diagram illustrating an embodiment in which a smart window display according to an embodiment of the present disclosure is installed outside a store.

In an embodiment of the present disclosure, the smart window display may be installed in a store. In this case, the store may be located within a shopping mall or may be located alone. The smart window display may be installed in the form of an entire window display or a partial window display of the store. For example, the smart window display may be installed on the entire exterior of the store or installed on a part of the exterior of the store. In this case, the smart window display may be transparent or opaque. In addition, the smart window display may be installed at least one location in the store. For example, the smart window may be installed not only on the exterior wall of the store but also on the dressing room and on the floor of the store.

Referring to FIG. 4, in step S410, the smart window display may identify a user outside the store through a camera. More specifically, when a shopper walks near the store in which the smart window display is installed, the camera of the smart window display may identify that the shopper is close to the store. In this case, the camera of the smart window display may identify user attributes of the shopper, such as a body type, height, age, and gender of the shopper.

Additionally, in one embodiment of the present disclosure, the smart window display may identify behavior and style attributes of the shopper outside the store through an integrated-type or attached-type camera. In this case, the camera may be located at an arbitrary area of the smart window display. Therethrough, the smart window display may provide personalized recommendations to the shopper outside the store, so that shopper outside the store may be attracted to the inside of the store.

In another embodiment of the present disclosure, the smart window display may be installed on a window outside the store to show the latest products of the store through mannequins, thereby attracting shoppers outside the store to the store. In this case, the smart window display may provide general recommendations rather than personalized recommendations of the shopper. In addition, the smart window display may support various digital experiences inside the store through a display.

In an embodiment of the present disclosure, the smart window display may identify shopping attributes and behaviors of shoppers outside the store using an integrated-type or attached-type camera.

In step S420, the smart window display may output personalized recommendations on the display in consideration of user attributes and style attributes of an identified user outside the store.

In addition, the smart window display installed outside the store may transmit, to another smart window display in the store, information about personalized recommendations recommended outside the store, when the shopper enters the store and is in the vicinity of the other smart window display in the store. Therethrough, the shopper who enters the store after seeing the personalized recommendations output on the smart window display outside the store may check the personalized recommendations again through another smart window display installed in the store. In addition, the smart window display outside the store may output personalized recommendations for other shoppers outside the store.

In an embodiment of the present disclosure, attributes and behaviors of shoppers outside the shopping store may be understood using the smart window display, and guidance to various convenience facilities within the shopping store may be provided using a connected digital device. Here, the connected digital device may correspond to a digital device of a user outside the store. In this case, the smart window display may transmit information related to various convenience facilities in the store to the digital device of the user outside the store through the communication unit.

Although not illustrated in the drawing, the smart window display may output a guide window for guiding shoppers on a store visit through the display after providing personalized recommendations to the shopper.

In one embodiment of the present disclosure, the smart window display may provide personalized recommendations whenever shoppers pass in front of the smart window display. Accordingly, the smart window display may stimulate the curiosity of the shoppers, and the number of times that the shoppers visit the store may increase. Therethrough, the amount of walking in front of the store in which the smart window display is installed may increase. Therethrough, the store may improve the visibility of products and increase sales.

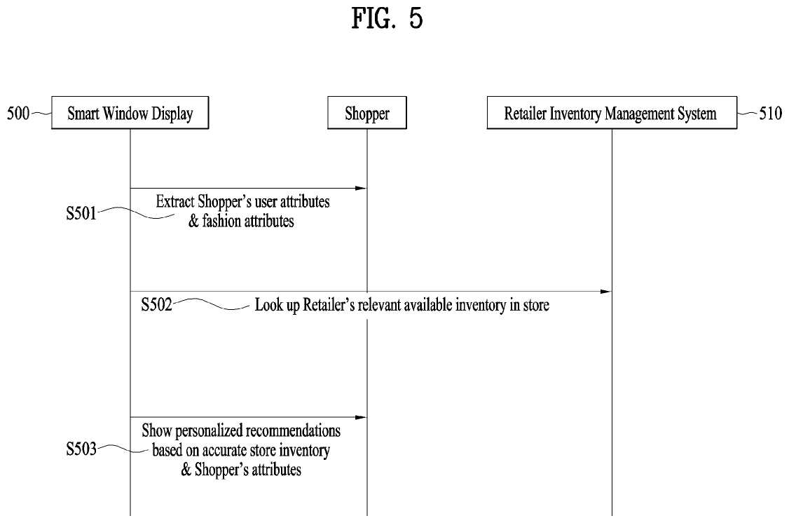

FIG. 5 is a diagram illustrating an embodiment in which a smart window display according to an embodiment of the present disclosure provides personalized recommendations by checking inventory details.

Referring to FIG. 5, a smart window display 500 may access an inventory management system 510 of a store through a communication unit.

More specifically, in step S501, the smart window display 500 may extract user attributes and style attributes of a shopper identified through a camera.

In step S502, the smart window display 500 may check products that are currently available in the store by accessing the inventory management system 510 of the store through the communication unit.

In step S503, the smart window display 500 may provide the shopper with personalized recommendations based on accurate inventory of the store and user attributes and style attributes of the shopper.

In another embodiment of the present disclosure, the smart window display 500 may provide the personalized recommendations in association with the inventory details of the store by being integrated with the management system 510 of the store. That is, the inventory management system 510 may be installed inside the smart window display 500 without being disposed outside the smart window display 500.

Accordingly, the smart window display 500 may provide the personalized recommendations to the shopper based on accurate inventory details in the shopping store.

When the personalized recommendations of the shopper are provided through the smart window display, if a product included in the personalized recommendations is out of stock at the corresponding store, the shopper may have a negative experience with respect to the corresponding store. In order to prevent such a negative opinion, the smart window display may provide the personalized recommendations in association with the inventory of the store.

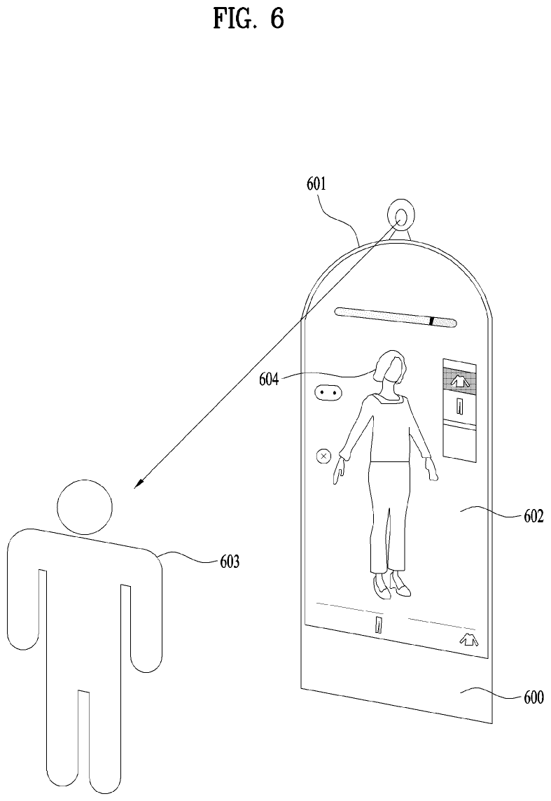

FIG. 6 is a diagram illustrating an embodiment in which a smart window display provides personalized recommendations using an avatar of an identified user according to an embodiment of the present disclosure.

Referring to FIG. 6, the smart window display 600 may recommend clothes or accessories that a user 603 is capable of purchasing by checking user attributes, style attributes of clothes and accessories that the user 603 is currently wearing, a purchase history, a personal preference, and inventory details of a current store.

In other words, the smart window display 600 may combine the user attributes, the style attributes of clothes and accessories currently being worn by the user 603 and recommend, using an algorithm of the controller or a predefined rule set, clothes and accessories that are expected to be purchased by the user 603.

These personalized recommendations may be output on a display 602 of the smart window display 600. In this case, the smart window display 600 may display only at least one of clothes and accessories as the personalized recommendations. In addition, the smart window display 600 may output products for the personalized recommendations to a virtual avatar 604 of a model or the user 603.

In an embodiment of the present disclosure, the smart window display 600 may identify the user 603 using a camera 601 and output the virtual avatar 604 corresponding to the identified user 603. For example, the smart window display 600 may generate the virtual avatar 604 in consideration of user attributes of the identified user 603.

In one embodiment of the present disclosure, the smart window display 600 may provide the personalized recommendations to the user 603 through the built-in display 602. In this case, the personalized recommendations may include, for example, a top (a shirt), a bottom (pants), and shoes.

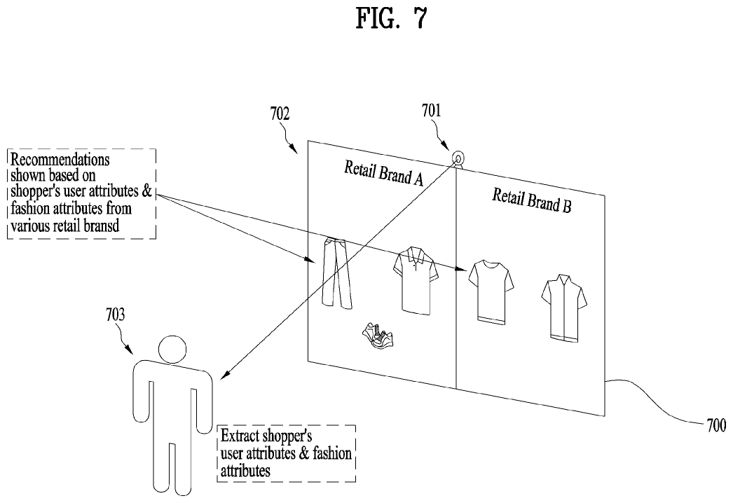

FIG. 7 is a diagram illustrating an embodiment in which a smart window display differently provides personalized recommendations for each brand according to an embodiment of the present disclosure.

Referring to FIG. 7, a smart window display 700 may differently provide personalized recommendations based on products sold in a store.

In more detail, the smart window display 700 may identify a user 703 by use of a camera 701 and then extract user attributes and style attributes of the identified user 703. Thereafter, the smart window display 700 may provide personalized recommendations based on the user attributes and style attributes of the identified user 703 through a display 702.

In an embodiment of the present disclosure, the smart window display 700 may distinguishably provide personalized recommendations based on a brand.

For example, if store A sells shirts, pants, and shoes, the smart window display 700 may provide personalized recommendations by putting a shirt, pants, and shoes on a virtual avatar of the user 703. In contrast, store B sells shirts and jackets, the smart window display 700 may provide personalized recommendations by putting a shirt and a jacket on the virtual avatar of the user 703.

Accordingly, the smart window display 700 of the present disclosure may distinguishably provide various branded products to the user 703. Similarly, if stores including various brands of products provide only details of inventory management systems of the stores to the smart window display 700, the smart window display 700 may automatically provide personalized recommendations based on a brand. That is, the smart window display 700 may be used universally in various stores without being limited to restricted products.

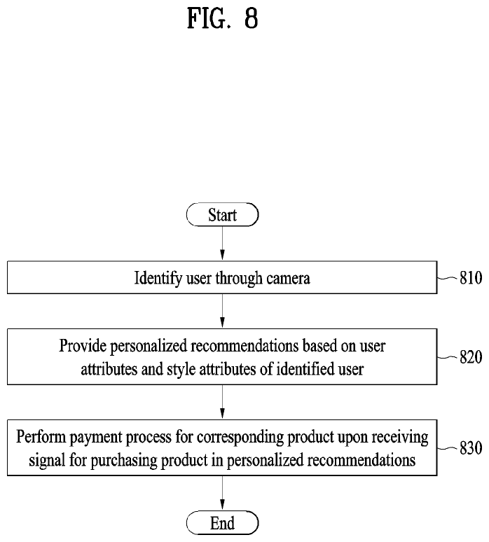

FIG. 8 is a flowchart illustrating an embodiment in which a smart window display provides personalized recommendations according to an embodiment of the present disclosure.

In step S810, the smart window display may identify a user through a camera. More specifically, the smart window display may identify a user through a built-in or detachable camera that is installed inside a store (e.g., a dressing room, a store floor, etc.) or outside the store.

In step S820, the smart window display may provide personalized recommendations based on user attributes and style attributes of the identified user. In more detail, the smart window display may distinguishably identify personal attributes, physical attributes, and color attributes as the user attributes. In addition, the smart window display may identify the style attributes through clothes and accessories that the user is wearing. In this case, the smart window display may distinguishably identify color, material, fabric, sleeve type, sleeve length, and neckline attributes of the clothes and accessories as style attributes.

In step S830, upon receiving a signal for purchasing a product in the personalized recommendations from the user after providing the personalized recommendations, the smart window display may perform a payment process for the product. More specifically, upon receiving a signal of touching the product in the personalized recommendations through a display or a signal of making a gesture through the camera from the user, the smart window display perform the payment process for the product. For the payment process, reference may be made to the above description given with reference to FIG. 3.

The present disclosure mentioned in the foregoing description can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy discs, optical data storage devices, and the like for example and also include carrier-wave type implementations (e.g., transmission via Internet). Further, the computer may include the controller 180 of the image editing device. The foregoing embodiments are merely exemplary and are not to be considered as limiting the present disclosure. The present teachings can be readily applied to other types of methods and apparatuses. Thus, it is intended that the present disclosure covers the modifications and variations of this disclosure that come within the scope of the appended claims and their equivalents.

What is claimed is:

1. A smart window display, comprising:
a display;
a camera configured to identify a user;
a communication unit configured to communicate with an external device; and
a controller,
wherein the controller provides personalized recommendations based on user attributes and style attributes of the user identified through the camera and performs a payment process of a product to be purchased in the personalized recommendations based on reception of a signal related to purchase of the product from the user after providing the personalized recommendations.

2. The smart window display of claim 1, wherein the controller
receives a purchase history of the user of the external device from the external device through the communication unit, and
provides the personalized recommendations based on the received purchase history.

3. The smart window display of claim 2, wherein the controller
analyzes a preference of the user of the external device based on the purchase history of the user of the external device from the external device, and
provides the personalized recommendations based on the analyzed preference.

4. The smart window display of claim 3, wherein the controller receives the preference from the external device.

5. The smart window display of claim 1, wherein the controller
accesses a store management system through the communication unit,
receives an inventory history from the store management system, and
provides the personalized recommendations based on the inventory history.

6. The smart window display of claim 5, wherein the signal related to purchase of the product includes at least one of a gesture signal of the user through the camera or a touch signal of the user through the display.

7. The smart window display of claim 6, wherein the controller performs the payment process through the store management system.

8. The smart window display of claim 1, wherein the user attributes include personal attributes, physical attributes, and color attributes of the user.

9. The smart window display of claim 1,
wherein the style attributes of the user include at least one of attributes of clothes worn currently by the user and attributes of accessories worn currently by the user, and
wherein the attributes of the clothes and the attributes of the accessories include at least one of color, texture, fabric, size, a sleeve type, a sleeve length, a pocket, and a neckline.

10. The smart window display of claim 1, wherein the controller outputs a guide window for guiding the user to visit a related store after providing the personalized recommendations based on the identified user being located outside of the store.

11. The smart window display of claim 1, wherein the controller
configures a priority between the user attributes and the style attributes of the identified user according to a preset value, and
provides the personal recommendations based on the configured priority.

12. The smart window display of claim 1, wherein the camera is integrated with the smart window display by being installed inside the smart window display.

13. The smart window display of claim 1, wherein the camera is attachable to or detachable from the smart window display.

14. The smart window display of claim 1, wherein the controller
generates a virtual avatar based on the identified user, and
outputs the personalized recommendations by applying the personalized recommendations to the avatar.

15. An operating method of a smart window display, the operating method comprising:
identifying a user through a camera;
providing personalized recommendations based on user attributes and style attributes of the identified user; and
performing a payment process of a product to be purchased in the personalized recommendations based on reception of a signal related to purchase of the product from the user after providing the personalized recommendations.
